(19) United States
(12) Patent Application Publication
(10) Pub. No.: US 2007/0011293 A1
(43) Pub. Date: Jan. 11, 2007

(54) System and method of managing printing data using an FTP and a user terminal device and an image forming device using the same

(75) Inventor: Si-eun Lee, Gwangmyeong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/475,181

(22) Filed: Jun. 27, 2006

(30) Foreign Application Priority Data
Jun. 28, 2005 (KR) 2005-56208

(51) Int. Cl. G06F 15/173

(52) U.S. Cl. 709/223

(57) ABSTRACT

A system to manage printing data using an FTP, the system includes a user terminal device to request a user authorization by transmitting certificate information using the FTP (File Transfer Protocol), and specifying at least one type of operation of storing and printing regarding at least one printing data to upload the printing data; and an image forming device in which the printing data is uploaded from the user terminal device using the FTP to perform the operation regarding the type of operation specified if authorization is granted, wherein the authorization is performed for the user authorization request from the user terminal device. Thus, it is possible to manage data using the existing FTP communication method between a user terminal device and an image forming device.

### CROSS-REFERENCE TO RELATED APPLICATIONS

This application claims benefit under 35 U.S.C. § 119 from Korean Patent Application No. 2005-56208 filed on Jun. 28, 2005 with the Korean Intellectual Property Office, the entire content of which is incorporated herein by reference.

### BACKGROUND OF THE INVENTION

1. Field of the Invention

The present general inventive concept relates to a system and a method of managing printing data using a File Transfer Protocol (FTP) and a user terminal device and an image forming device using the same, and more particularly, to a system and a method of managing printing data using an FTP, which is capable of uploading and managing data to the image forming device having a high-capacity storage media, and a user terminal device and an image forming device using the same.

2. Description of the Related Art

Among various input/output devices which are used increasingly due to office automation, a Laser Beam Printer, an LPH (LED Print Head) printer, a copier, a facsimile and the like are commonly referred to as an image forming device.

A conventional image forming device has been configured so that functions of a printer, a copier and the like exist individually within a single device. However, a multi function printer (MFP) being used recently includes various functions of a printer, a scanner, a facsimile and the like equipped in a single device with progress of digital technology.

Such a multi function printer is provided with its own function, such as a printing function of the printer, a scanning function of the scanner, and the like, as well as being configured to transmit/receive data with a variety of communication modules.

Further, the prior art image forming device is provided with small-capacity memory enough to temporarily store data provided from a host device until it is outputted, whereas it tends to be equipped with high-capacity memory equal to that of a hard disk drive (HDD) of the host device lately.

Using the image forming device with such a high-capacity memory, it is possible to configure the printing system as a type of FTP (File Transfer Protocol) system. Here, the image forming device corresponds to an FTP server, and at least one host device connected with the image forming device can correspond to FTP clients, thereby performing their functions respectively.

In considering a prior art FTP printing system including the image forming device and the host device, the host device uploads a file to the image forming device and the image forming device performs the printing operation of data uploaded.

As such, since the prior art FTP printing system including the image forming device and the host device is a simple type that prints data uploaded to the image forming device, there is a need for a scheme of utilizing high-capacity memory of the image forming device more efficiently.

### SUMMARY OF THE INVENTION

The present general inventive concept provides a system and a method of managing printing data using a File Transfer Protocol (FTP), and user a terminal device and an image forming device using the same which are capable of efficiently managing printing data regarding a type of operation specified by a user, by applying the existing FTP communication method.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a system to manage printing data using a File Transfer Protocol (FTP) including a user terminal device to request a user authorization by transmitting certificate information using the FTP, and specifying at least one type of operation of storing and printing regarding at least one printing data to upload the printing data; and an image forming device in which the printing data is uploaded from the user terminal device using the FTP to perform the operation regarding the type of operation specified if authorization is granted, wherein the authorization is accomplished for the user certificate request from the user terminal device.

The type of operation can include “storing,” “printing after storing,” and “deleting after printing.”

The image forming device can be uploaded with the printing data and then can store the uploaded printing data in a folder designated according to the type of operation specified.

The user terminal device can designate a folder to store the printing data according to the type of operation specified and then can upload the printing data to the designated folder.

The user terminal device can generate a script file according to the type of operation specified, and can upload the printing data along with the script file generated.

The foregoing and/or other aspects and utilities of the present general inventive concept are also achieved by providing a method of managing printing data in a system where a user terminal device and an image forming device transmits and receives the printing data using a File Transfer Protocol (FTP), the method including requesting a user authorization by transmitting certificate information by the user terminal device, performing the authorization for the user authorization request by the image forming device, receiving at least one type of operation of storing and printing regarding the printing data to be uploaded from the user terminal device if the user authorization is granted, and uploading the type of operation and the printing data to the image forming device, and performing the operation regarding the type of operation on the printing data by the image forming device.

The type of operation can include “storing,” “printing after storing,” and “deleting after printing.”

The method may further include storing the uploaded printing data in a folder designated according to the type of operation specified in the image forming device.

In the uploading, the user terminal device can designate a folder to store the printing data according to the type of operation inputted and can upload the printing data to the designated folder.

In the uploading, the user terminal device can generate a script file including the type of operation inputted and can upload the printing data along with the script file generated.

The foregoing and/or other aspects and utilities of the present general inventive concept are also achieved by providing a user terminal device using a File Transfer Protocol (FTP) including a user interface unit in which certificate information and at least one type of operation of storing and printing regarding printing data to be uploaded are inputted from a user, an image forming device interface unit to request a user authorization by transmitting the inputted certificate information to the image forming device using the FTP, and a first control unit to control the image forming device interface unit to upload the type of operation and the printing data inputted, if the authorization is granted for the user certificate request from the image forming device.

The type of operation can include “storing,” “printing after storing,” and “deleting after printing.”

The user terminal device can further include a script file generating unit to generate a script file including the type of operation inputted.

The foregoing and/or other aspects and utilities of the present general inventive concept of the present inventive concept are also achieved by providing an image forming device using a File Transfer Protocol (FTP), the image forming device including a certification unit to perform an authorization for a user authorization request from a user terminal device, a terminal device interface unit to which printing data is uploaded from the user terminal device using the FTP, if the authorization is granted by the certification unit, an operation performing unit to perform an operation regarding the printing data, a second control unit to control the operation performing unit to perform an operation regarding at least one type of operation of storing and printing specified of the printing data, if the printing data is uploaded.

The second control unit can control storing the uploaded printing data in a folder which is designated according to the type of operation specified.

The operation performing unit can perform an operation corresponding to the folder in which the printing data is stored.

The terminal device interface unit can be uploaded with the printing data along with a script file including the type of operation specified..

The second control unit can interpret the script file to receive the type of operation specified of the printing data.

The image forming device can further include a data converting unit to convert the printing data into a form that is recognizable, if the uploaded printing data is not recognizable.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of user terminal device using a File Transfer Protocol (FTP) in accordance with an embodiment of the present general inventive concept;

FIG. 2 is a block diagram of an image forming device using an FTP in accordance with the embodiment of FIG. 1;

FIGS. 3A and 3B are diagrams illustrating operations of a storage unit of FIG. 2.

FIG. 4 is a flow chart illustrating a method of operating the user terminal device of FIG. 1 using an FTP according to an embodiment of the present general inventive concept.

FIG. 5 is a flow chart illustrating a method of operating the image forming device of FIG. 2 using an FTP according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A system to manage printing data using a File Transfer Protocol (FTP) according to an embodiment of the present general inventive concept includes at least one user terminal device and an image forming device which are connected through any connecting method to transmit/receive data mutually.

Here, the user terminal device performs a typical function of an FTP client, and the image forming device performs a typical function of an FTP server. The user terminal device and the image forming device may be connected with each other via a wired or wireless network.

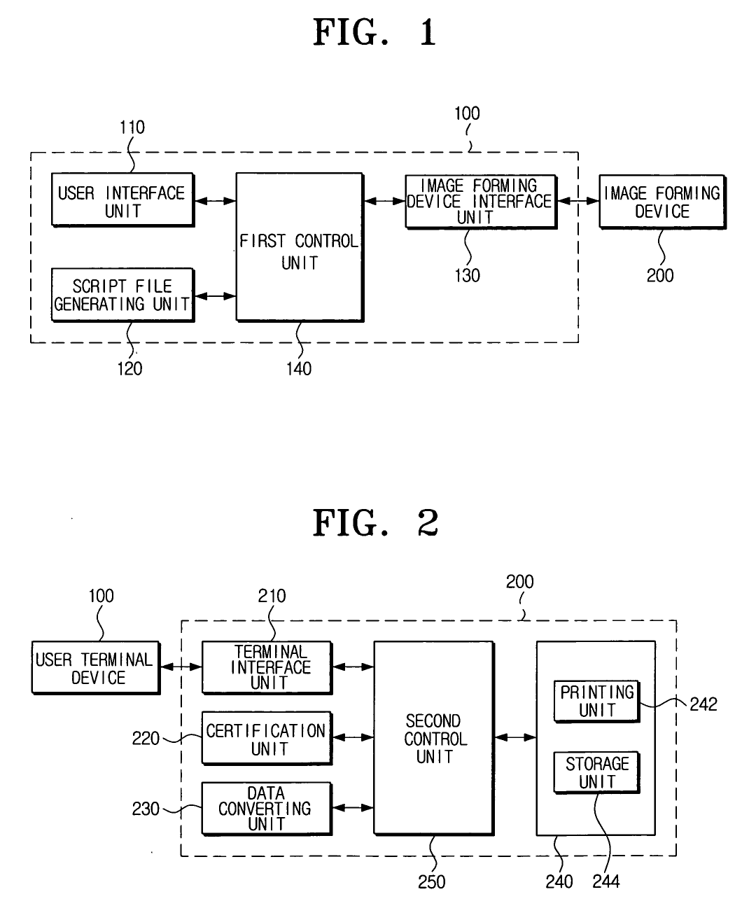

FIG. 1 is a block diagram of a user terminal device using an FTP in accordance with an embodiment of the present general inventive concept.

Referring to FIG. 1, the user terminal device 100 according to the present embodiment includes a user interface unit 110, a script file generating unit 120, an image forming device interface unit 130 and a first control unit 140. The user terminal device 100 can be connected with the image forming device 200 through any connecting method.

The user interface unit 110 supports an interface between a user and the user terminal device 100. Certificate information and a type of operation regarding the printing data to be uploaded to the image forming device 200 are inputted to the user interface unit 110 from a user. Here, the certificate information can include a unique user ID and a password corresponding to it. Also, the printing data is data that is intended to print or store for a long time by means of the image forming device 200.

The type of operation selected by the user may include operations of “storing,” “printing after storing,” and “deleting after printing,” and the user can select any one of these operations in accordance with how to process the printing data. Here, “storing” is to perform only the operation of storing the printing data, “printing after storing” is to perform both the operations of storing and printing the printing data, and “deleting after printing” is to perform only operation of printing the printing data.

The script file generating unit 120 generates a script file according to the type of operation of the printing data inputted via the user interface unit 110. The image forming device 200 can receive the type of operation regarding the printing data by the script file generated by the script file generator 120.

The image forming device interface unit 130 supports an interface between the image forming device 200 and the user terminal device 100. The image forming device interface unit 130 requests a user certificate by transmitting the certificate information to the image forming device 200, and uploads the printing data to the image forming device 200 if an authorization is granted by the image forming device 200 based on the certificate information received.

The first control unit 140 is used to control overall functions of the user terminal device 100, and controls input/output of signals among the user interface unit 110, the script file generating unit 120 and the image forming device interface unit 130.

If the authorization for the user certificate request is granted from the image forming device 200, the first control unit 140 controls the image forming interface unit 130 to upload the type of operation and the printing data inputted from the user interface unit 110.

FIG. 2 is a block diagram of the image generating device 200 according to an embodiment of the present general inventive concept.

Referring to FIG. 2, the image forming device 200 according to the present embodiment includes a terminal interface unit 210, a certification unit 220, a data converting unit 230, an operation performing unit 240 and a second control unit 250.

The terminal interface unit 210 supports an interface between the user terminal device 100 and the image forming device 200. In this embodiment, the printing data is uploaded to the terminal interface unit 210 from the user terminal device 100, if the authorization is granted by the certification unit 220 as described below.

The certification unit 220 performs the authorization for the authorization request from the user terminal device 100. That is, the certification unit 220 compares pre-registered user information with the certificate information inputted from the user terminal device 100 via the terminal interface unit 210, and grants the authorization only if both the pre-registered user information and the certificate information is identical. It is possible to upload the printing data from the user terminal device 100 to the image forming device 200 only if the authorization is granted by the certification unit 220.

If the printing data uploaded from the user terminal device 100 via the terminal interface 210 is in a form that is not recognizable in the image forming device 200, the data converting unit 230 converts the printing data into a form that is recognizable.

In other words, if data is generated and uploaded in a form of a prn file by a typical driver program equipped in the user terminal device 100, the image forming device 200 can recognize it, and therefore a separate converting process will not be necessary.

However, if the uploaded printing data is a file that is not converted by the driver program, for example, in forms such as doc, xls, hwp, etc., the image forming device 200 can not recognize it. Therefore, the image forming device 200 can eventually recognize it by converting the uploaded printing data into a form that is recognizable by means of the data converting unit 230.

The data converting unit 230 can convert the uploaded printing data into a page description language to generate the printing data. This is possible because the printer driver can be embedded in the image forming device 200.

The operation performing unit 240 performs a desired operation regarding the printing data uploaded via the terminal interface unit 210 by a control of the second control unit 250. For this purpose, the operation performing unit 240 includes a printing unit 242 and a storage unit 244.

If the type of operation specified of the printing data is “printing after storing” or “deleting after printing,” the printing unit 242 provides the user with the printing data outputted on any printing paper.

If the type of operation specified of the printing data is a “storing” or “printing after storing,” the storage unit 244 stores the printing data uploaded from the user terminal device 100. Here, the storage unit 244 has a high-capacity storage space so that it can store and manage a plurality of printing data for a long period of time.

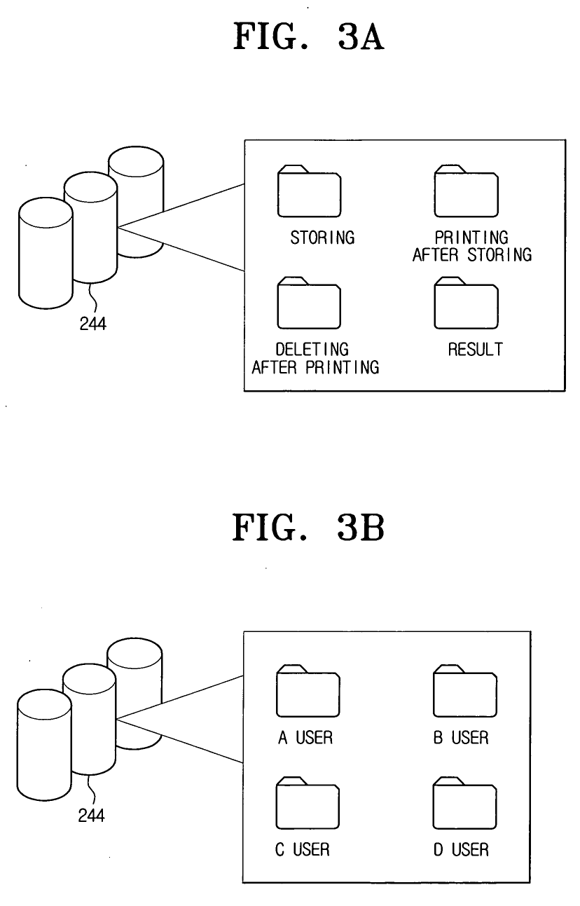

The storage unit 244 has a function of storing the printing data in a separate folder. At this time, the folders in the storage unit 244 are capable of being generated or deleted randomly. The folders in the storage unit 244 will be described more specifically with regard to FIGS. 3A and 3B illustrated below.

The second control unit 250 is used to control overall functions of the image forming device 200 and controls input/output of signals among the terminal interface unit 210, the certification unit 220, and the operation performing unit 240 including the printing unit 242 and the storage unit 244.

If the printing data is uploaded from the user terminal device 100 via the terminal interface unit 210, the second control unit 250 controls the operation performing unit 240 to perform the operation regarding the type of operation specified of the uploaded printing data.

In other words, the second control unit 250 controls to store the printing data in the storage unit 244 if the type of operation specified of the printing data is “storing,” to output the printing data by the printing unit 242 along with storing it in the storage unit 244 if the operation specified of the printing data is “printing after storing,” and to output the printing data by the printing unit 242 and then delete the printing data without storing it in the storage unit 244 if the operation specified of the printing data is “deleting after printing.” Here, the second control unit 250 can control to store the printing data in a folder designated in accordance with the type of operation specified of the printing data in terms of storing it in the storage unit 244.

If a script file will be uploaded along with the printing data from the user terminal device 100, the second control unit 250 controls the operation performing unit 240 so that it can interpret the script file, receive the type of operation specified of the printing data, and perform the operation in accordance with the type of operation specified.

FIG. 3 is a diagram illustrating a function of the storage unit as illustrated in FIG. 2.

As described above, the storage unit 244 has a high-capacity storage space enough to store and manage a plurality of printing data in order to implement the typical FTP server function in the image forming device 200. Also, the storage unit 244 can store and manage the plurality of printing data in a separate folder as shown.

FIG. 3A illustrates an exemplary case in which folders of “storing,” “printing after storing,” “deleting after printing,” and a folder of “result” of storing the result of operation performance are generated in the storage unit 244 in terms of the type of each operation specified. FIG. 3B illustrates an exemplary case in which folders of “A user,” “B user,” “C user” and “D user,” are generated in terms of each user. This is not limiting, and it is possible to change names of the folders generated in the storage unit 244 if necessary.

Here, each folder in FIG. 3B can be contained within each folder in FIG. 3A, and in contrast, each folder in FIG. 3A can be contained within each folder in FIG. 3B. For example, the folders of “storing,” “printing after storing,” and “deleting after printing,” can be contained within each folder of “A user,” “B user,” “C user,” and “D user.”

The user can specify the type of operation regarding the printing data by selecting a folder in which to store the printing data to upload to the image forming device 200 by means of the user interface unit 110 of the user terminal device 100.

Further, if the printing data is uploaded in the folder designated from the user terminal device 100, the image forming device 200 stores the uploaded printing data in the corresponding folder and performs the operation corresponding to that folder on the printing data within the folder.

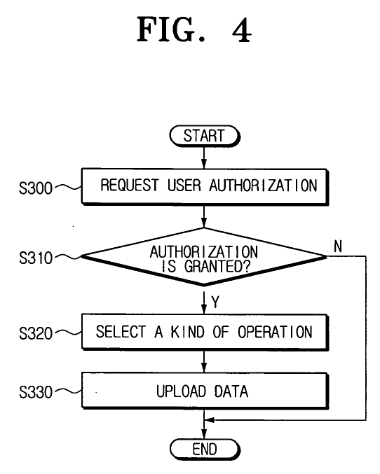

FIG. 4 is a flow chart illustrating a method of operating the user terminal device 100 using an FTP according to an embodiment of the present general inventive concept.

The method of operating the user terminal device 100 according to this embodiment will be described below with reference to FIG. 1 through FIG. 4.

The user inputs the certificate information via the user interface unit 110, and then the certificate information inputted from the user is provided from the user interface unit 110 to the first control unit 140. By control of the first control unit 140, the image forming device interface unit 130 requests a user authorization by transmitting the certificate information inputted to the image forming device 200 (operation S300).

If the authorization is granted from the image forming device 200, the user can select the type of operation regarding data to be uploaded, i.e. any one of “storing,” “printing after storing,” and “deleting after printing,” by means of the user interface unit 110. The user interface unit 110 provides the first control unit 140 with the type of operation selected by the user. If the type of operation is selected, the first control unit 140 controls the script file generating unit 120 to generate a script file including the type of operation selected (operations S310 to S320).

Hereafter, the first control unit 140 uploads the corresponding printing data and the type of operation specified of the printing data to the image forming device 200 via the image forming device interface unit 130. At this time, the image forming device interface unit 130 uses an FTP. If the script file is generated according to the type of operation specified, the first control unit 140 may also upload the printing data along with the script file.

If the authorization is not granted from the image forming device 200 in operation S310, the user certificate information is not correct, and therefore it is not possible to connect the user terminal device 100 with the image forming device 200. In such a case, the user can re-input the certificate information by means of the user interface unit 110, and the user terminal device 100 can re-try to connect with image forming device 200.

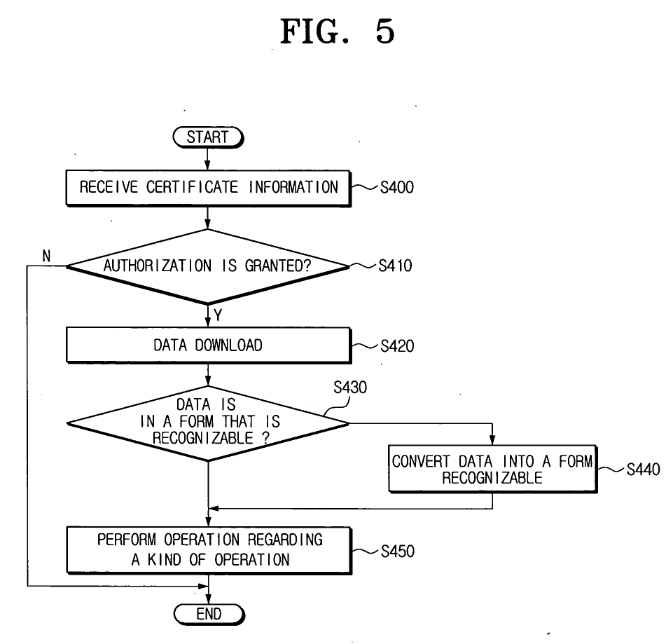

FIG. 5 is a flow chart illustrating a method of operating the image forming device according to an embodiment of the present general inventive concept.

A method of operating the image forming device 200 according this embodiment will be described below, with reference to FIG. 1 to FIG. 5.

The image forming device 200 receives the certificate information including a user's unique ID and password from the user terminal device 100 via the terminal interface unit 210, by which the user certificate is requested (operation S400).

The second control unit 250 provides the certification unit 220 with the certificate information received via the terminal interface unit 210. The certification unit 220 compares the certificate information with pre-registered user information and then grants authorization only if both the certificate information and the pre-registered user information is identical. If the authorization is granted by the certification unit 220, the second control unit 250 informs that the authorization is granted to the user terminal device 100 via the terminal interface unit 210, and then the image forming device 200 is uploaded with the printing data (operations S410 to S420).

If the printing data will be uploaded from the user terminal device 100 via the terminal interface unit 210, the second control unit 250 may determine whether the uploaded printing data is data in a form that is recognizable, i.e. prn file. (operation S430).

The second control unit 250 may control the operation performing unit 240 to perform an operation regarding the type of operation specified of the printing data, if the uploaded printing data is data in a form that is recognizable in operation S430 (operation S450).

The second control unit 250 may control the data converting unit 230 to convert the printing data into a form that is recognizable, if the uploaded printing data is in a form that is not recognizable to the image forming device 200 in operation S430 (operation S440).

If the printing data is converted into a form that is recognizable by the data converting unit 230, the second control unit 250 controls the operation performing unit 240 to perform the operation regarding the type of operation that is specified of the printing data (operation S450).

As such, by performing only a simple operation of designating a folder in which printing data to be uploaded to the image forming device 200 is to be stored by means of the user terminal device 100, the image forming device 200 can receive a user's intent on how to process the printing data and can perform the operation according to the user's intent.

As described above, a system and method to manage printing data using an FTP and a user terminal device, and an image forming device using the same according to various embodiments of the present general inventive concept can store and manage the printing data easily by using the image forming device with high-capacity storage space to which an existing FTP communication method is applied as is.

The operations such as “storing,” “printing,” and “printing after storing” can be easily performed in accordance with a user's intent, since a user can specify the type of operation regarding data to upload.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system to manage printing data using a File Transfer Protocol (FTP), the system comprising:
at least one user terminal device to request a user authorization by transmitting certificate information using an FTP (File Transfer Protocol), and specifying at least one type of operation of storing and printing regarding at least one printing data to upload the printing data; and
an image forming device in which the printing data is uploaded from the at least one user terminal device using the FTP to perform the operation regarding the type of operation specified if the authorization is granted, wherein the authorization is performed for the user authorization request from the at least one user terminal device.

2. The system according to claim 1, wherein the type of operation includes “storing,” “printing after storing,” and “deleting after printing.”

3. The system according to claim 1, wherein the image forming device is uploaded with the printing data and then stores the uploaded printing data in a folder designated according to the type of operation specified.

4. The system according to claim 1, wherein the at least one user terminal device designates a folder in which to store the printing data according to the type of operation and uploads the printing data.

5. The system according to claim 1, wherein the at least one user terminal device generates a script file according to the type of operation and uploads the printing data along with the script file generated.

6. The system according to claim 1, wherein the at least one user terminal device comprises:
a user interface unit to support an interface between a user and the respective user terminal device;
a script file generating unit to generate a script file according to the type of operation of the printing data inputted via the user interface unit so that the image forming device can receive the type of operation regarding the printing data by the script file 7; and
an image forming device interface unit to support an interface between the image forming device and the user terminal device.

7. The system according to claim 6, wherein the user terminal device further comprises:
a first control unit to control overall functions of the user terminal device and to control input and/or output of signals among the user interface unit, the script file generating unit and the image forming device interface unit.

8. The system according to claim 6, wherein the image forming device comprises:
a terminal interface unit to support an interface between the user terminal device and the image forming apparatus;
a certification unit to perform the authorization for the authorization request from the user terminal device;
a data converting unit to convert the printing data uploaded from the user terminal device if the printing data is in a form not recognizable in the image forming apparatus; and
an operation performing unit to perform a desired operation regarding the printing data uploaded via the terminal device interface unit.

9. The system according to claim 8, wherein the image forming device further comprises;
a second control unit to control overall functions of the image forming device and controls input and/or output signals among ther terminal device interface unit, the certification unit, and the operation performing unit.

10. The system according to claim 1, wherein the certification information includes a unique user ID and a password corresponding to the user ID.

11. A method of managing printing data in a system where at least one user terminal device and an image forming device transmits and receives the printing data using an FTP, the method comprising:
requesting a user authorization of the image forming device by transmitting certificate information via the at least one user terminal device;
performing an authorization operation for the user authorization request by the image forming device;
receiving at least one type of operation of storing and printing regarding the printing data to be uploaded from the at least one user terminal device if the user authorization is granted, and uploading the type of operation and the printing data to the image forming device; and
performing the operation regarding the type of operation on the printing data by the image forming device.

12. The method according to claim 11, wherein the type of operation includes “storing,” “printing after storing,” and “deleting after printing.”

13. The method according to claim 11, further comprising storing the uploaded printing data in a folder designated according to the type of operation specified by the image forming device.

14. The method according to claim 11, wherein, in the uploading, the at least one user terminal device designates a folder in which to store the printing data according to the type of operation inputted and uploads the printing data.

15. The method according to claim 11, wherein, in the uploading, the at least one user terminal device generates a script file including the type of operation inputted and uploads the printing data along with the script file generated.

16. A user terminal device using an FTP, the user terminal device including:
a user interface unit in which certificate information and at least one type of operation of storing and printing regarding printing data to be uploaded are inputted from a user;
an image forming device interface unit to request user authorization by transmitting the inputted certificate information to the image forming device using the FTP; and
a first control unit to control the image forming device interface unit to upload the type of operation and the printing data inputted, if the authorization is granted for the user authorization request from the image forming device.

17. The user terminal device according to claim 16, wherein the type of operation includes “storing,” “printing after storing,” and “deleting after printing.”

18. The user terminal device according to claim 16, further including a script file generating unit to generate a script file including the type of operation inputted

19. An image forming device using an FTP, including:
a certification unit to perform an authorization for a user authorization request from a user terminal device;
a terminal interface unit to which printing data is uploaded from the user terminal device using the FTP, if the authorization is granted by the certification unit;
an operation performing unit to perform an operation regarding the printing data; and
a second control unit to control the operation performing unit to perform an operation regarding at least one type of operation of storing and printing specified of the printing data, if the printing data is uploaded.

20. The image forming device according to claim 19, wherein the second control unit controls to store the uploaded printing data in a folder which is designated according to the type of operation specified.

21. The image forming device according to claim 20, wherein the operation performing unit performs an operation corresponding to the folder in which the printing data is stored.

22. The image forming device according to claim 21, wherein the operation performing unit comprises:
a printing unit to perform outputting of the printing data; and
a storing unit to perform storing of the printing data.

23. The image forming device according to claim 19, wherein the terminal device interface unit is uploaded with the printing data along with a script file including the type of operation specified.

24. The image forming device according to claim 22, wherein the second control unit interprets the script file to receive the type of operation specified of the printing data.

25. The image forming device according to claim 19, further including a data converting unit to convert the printing data into a form that is recognizable, if the uploaded printing data is not recognizable.
